(19) United States
(12) Patent Application Publication
(10) Pub. No.: US 2009/0157553 A1
(43) Pub. Date: Jun. 18, 2009

(54) Purchase of electronic content after a trial or rental period of using content without access to an internet connection

(75) Inventors: William Wang, Newport Beach, CA (US); Timothy Elliott, Huntington Beach, CA (US); William Pat Price, Rhome, TX (US)

Correspondence Address: Law Office of Scott C Harris Inc, PO Box 1389, Rancho Santa Fe, CA, 92067, US

(73) Assignee: VIZIO, Irvine, CA (US)

(21) Appl. No.: 11/958,370

(22) Filed: Dec. 17, 2007

(51) Int. Cl. G06Q 30/00; H04L 9/00

(52) U.S. Cl. 705/59; 705/26

(57) ABSTRACT

A customer can rent and later buy digital content that is encoded onto rewritable media where the customer had selected at least one piece of content to be encoded on the media. The user has the ability to use the previously selected content and later purchase the content without the need to interact with the content seller indicating the desire to purchase the content. Purchased content is transferred to customer's local storage device. The rewritable media can also contain other digital content from which the user can temporary access after which he can rent or purchase the content.

### BACKGROUND

The rental of digital content in the form of movies, games, software, and music has been in existence for many years. These businesses would normally rent content on media such as Compact Disks, DVDs, or game cartridges. Initially rental businesses specializing in renting these types of content tended to only rent and not sell the content.

CD and DVD media containing digital content has a life expectancy based on media wear. The surface of the media becomes scratched over time from handling and at some point in time becomes difficult to use or even unusable. Electronic game cartridges also have a life expectancy that is based on the wear of the cartridge connector.

Some game rental operations sell their cartridges once the cartridge nears its end of life period. Selling a cartridge near its end of life generally provides a better revenue opportunity for the rental business than taking the salvage value of the media once it is no longer usable.

There is a certain demographic of customers who, given the opportunity, would purchase digital content once they have viewed or used the content. Customers however are not likely to purchase, at full price, a piece of media that has any amount of use and which may not be usable over a long period of time. Because of this, the purchase option for rental media is generally only viable for deeply discounted content, where the media is near its end of life.

Making digital content available for rent via downloading from the internet would guarantee the customer has a fresh copy that is not subject to wear and tear. Content owners however are generally not willing to make their content available in that form due to the opportunity for theft. Coupled with what would be relatively long download times, this model for rental never became viable.

### SUMMARY

Embodiments addressed herein relate to the customer issue of renting then purchasing digital content such as video, games, books, and software applications. Embodiments describe how this can be done without an internet connection.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 is a diagram depicting one embodiment of the invention for renting and purchasing digital files including delivery of said files on rewritable media;

FIG. 2 is a diagram depicting how digital files that are transferred by the media player from the rewritable media to an external storage device are marked with some identifying data that links the digital file to the external storage device;

FIG. 3 is a diagram depicting how digital files residing on the rewritable media and purchased by the customer are marked as having been purchased such that the system can identify that the file has been purchased once the rewritable media has been returned to the system for processing; and

FIG. 4 is a diagram depicting how digital files not originally selected by the customer and residing on the rewritable media and played or used by the customer are marked as having been rented such that the system can identify that the file has been rented once the rewritable media has been returned to the system for processing.

### DETAILED DESCRIPTION OF EMBODIMENTS

The present embodiments disclose a new payment methodology for media rental models. This embodiment accommodates both the customer who is sophisticated enough to manage internet based commerce sites, and also the customer who cannot. The embodiment simplifies the process which allows a customer to rent digital content. Then, once having used the content, the presently disclosed system makes the purchase of the content relatively easy.

The customer may initiate a rental of digital content using an internet account. When the customer first selects content to be rented, billing and credit information will already be in the system's databases. At the time, the system obtains the media for the customer. The system will have debited the customer's account for the rental.

In an embodiment, the system may produce the media, by writing the information on a writable media device. The system may also place other digital content on the same piece of media. This content may then be previewed at the customer's option; then rented and/or purchased at a later date at the customer's option.

The customer receives the media with the rental content, and plays it on their media player.

The customer can also indicate an indication to purchase the content. If done, the media player device copies the content to the customer's local storage device. The local storage device can be a hard drive, a DVD writer, a CD writer, or the like. The local storage device can be removable and separate, connectable to the media player over a connector. The media player then places a digital token or file on the media.

The media is eventually returned to the system for refreshing, e.g., by mail. At that time, the system detects the token, and accordingly debits the customer's account for the content purchase or for the additional rentals that took place. This is all done without the need for an internet connection, since everything is written on the token, and then read from the token once the media has been returned.

The embodiments provide the customer the ability to add digital media to their digital library. The customers do not need to use a digital storage device that has an internet connection.

Music content owners traditionally have not been agreeable to renting or previewing complete tracks of music on CDs because of the ease in which these CDs can be copied. An embodiment also addresses this concern.

All content, including music, that is placed on the rental media is securely encrypted and keyed or linked to the customer and the players owned by the customer. The metadata associated with the content has the ability to limit the music tracks that can be played for free, the time, e.g., number of seconds any given track can be played for free, and the amount of time a given track remains valid before expiring and becoming non accessible.

For example, one or more music tracks may be placed on the same media on which a rental movie is placed. The customer is given the ability to listen to the music partial or full track and then purchase the music. After that, the music is transferred, in its encrypted form, to the customer's local storage device. This provision allows customers to purchase the music sound tracks associated with a movie, at a time that their interest in that soundtrack will presumably be at its peak.

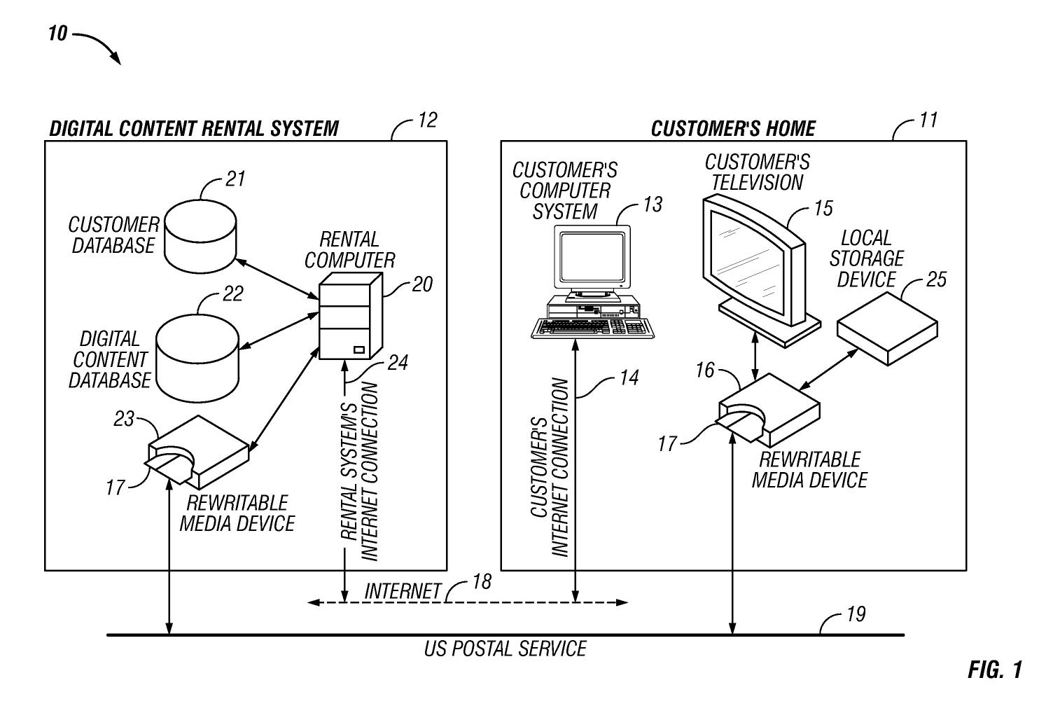

FIG. 1 illustrates an embodiment 10 whereby the Customer's Home 11 is depicted containing Customer's Computer System 13, Customer's Internet Connection 14, Customer's Television 15, Local Storage Device 25, Media Player 16, and Rewritable Media 17. Digital Content Rental System 12 is depicted containing Rental Computer 20, Customer Database 21, Digital Content Database 22, Rental System's Internet Connection 24, Rewritable Media 17 and Rewritable Media Device 23. Communications between Customer's Home 11 and Digital Content Rental System is through Internet 18 and/or via the U.S. Postal Service 19.

The customer uses Customer's Computer System 13 to initiate a session to access Digital Content Rental System 12 through Customer's Internet Connection 14 to the Internet 18 and Rental System's Internet Connection 24. Customer and Rental Computer 13, as part of an initial session, creates a customer account on Customer Database 21 which includes the customer's shipping address and credit information. Customer's previously entered credit information is used to bill customer for digital content that customer rents or purchases.

During a rental session initiated by the customer, Rental Computer 20 accesses Digital Content Database 22 and sends a list of digital content files to Customer's Computer System 13 that customer may rent.

Once customer has selected one or more items of digital content files to rent, customer's selections are sent by Customer's Computer System 13 to Digital Content Rental System 12 via Internet 18, Customer's Internet Connection 14, and Rental System's Internet Connection 24. Once Rental Computer 20 receives the customer's rental selection, it bills the customer's credit account based on information in the customer's account contained on Customer Database 21 and transfers the selected digital content files from Digital Content Database 22 to Rewritable Media Device 23. The rewritable media device is then used to writes the digital content files onto Rewritable Media 17. Digital Content Rental System 12 then causes Rewritable Media 17 to be transferred to the customer via a delivery mechanism. In the preferred embodiment, the delivery mechanism is the United States Postal Service. In alternate embodiments the delivery mechanism may be any package/parcel delivery service including but not limited to FedEx or UPS.

The customer receives Rewritable Media 17 and inserts the media into Media Player 16. Media Player 16 reads the digital content file from Rewritable Media 17 and plays the content on Customer's Television 15. Once the digital content file has been played, Media Player 16 displays an option to the customer that allows the user to purchase the digital content file as played. In an embodiment, the option to purchase the digital content file is displayed by the media player, on Customer's Television 15. The customer indicates their desire to purchase, or not to purchase, the digital content file by pressing a button on the hand held remote control device for Media Player 16 or for Customer's Television 15.

In alternate embodiments, Media Player 16 may display the purchase option to the customer through a light or LED that is illuminated with a steady illumination or with a flashing illumination. The customer indicates their desire to purchase or not to purchase the digital content file just played by pressing a button on the hand held remote control device for Media Player 16 or by pressing a labeled button on the Media Player 16.

In another alternate embodiment, Media Player 16 may display the purchase option to the customer through a textual display on Media Player 16. The customer indicates a desire to purchase or not to purchase the digital content file just played by pressing a button on the hand held remote control device for Media Player 16 or by pressing a labeled button on the Media Player 16. If the customer indicates a desire to purchase the digital content file that Media Player 16 just played on Customer's Television 15, Media Player 16 transfers the digital content file as just played to Local Storage Device 25; after which Media Player 16 writes a small encrypted file onto Rewritable Media 17. Customer, after using said digital content files residing on Rewritable Media 17, sends the Rewritable Media 17 back to Digital Content Rental System 12.

Rewritable Media 17 is received by Digital Content Rental System 12 and inserted into Rewritable Media Device 23. Rental Computer System 20 reads the contents of Rewritable Media 17 to determine if there are any tokens on Rewritable Media 17 indicating customer purchased digital content files. If tokens are found on Rewritable Media 17, Rental Computer 20 debits customer's account for the purchase.

In another embodiment, Rental Computer 20 may place additional digital content files on Rewritable Media 17. Rewritable Media Player 16 looks for additional digital content files on Rewritable Media 17. If those digital content files are found, they are displayed to the customer. If customer indicates that they want to rent one of the digital content files, Rewritable Media Player 16 plays that file on Customer's Television 15. Rewritable Media Player 16 also writes a small encrypted file onto Rewritable Media 17 to indicate that customer rented the digital content file.

Customer, after using said digital content files residing on Rewritable Media 17, sends the Rewritable Media 17 back to Digital Content Rental System 12. Once Rewritable Media 17 is received by Digital Content Rental System 12, said Rewritable Media 17 is inserted into Rewritable Media Device 23. Rental Computer System 20 reads the contents of Rewritable Media 17 to determine if there are any tokens on Rewritable Media 17 indicating that customer rented digital content files not originally requested by customer. If tokens are found on Rewritable Media 17, Rental Computer 20 debits customer's account for a price of the rentals.

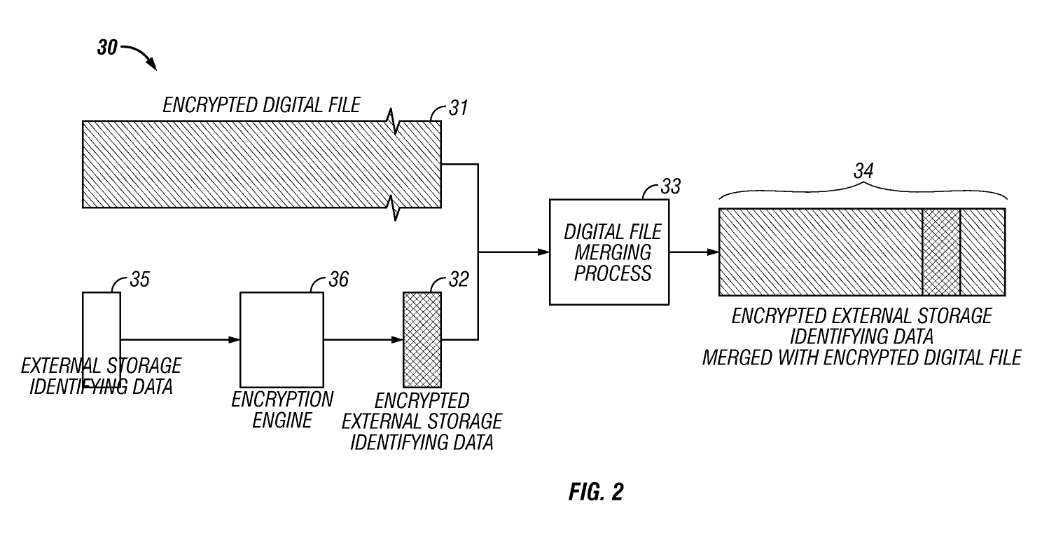

FIG. 2 shows an embodiment illustrating how digital files transferred by Media Player 16 from Rewritable Media 17 to Local Storage Device 25 are marked with an identifying data that links that file to Local Storage Device 25. Once the customer indicates that they want to purchase the digital content file that was just used, Media Player 16 sends an inquiry command to Local Storage Device 25. Local Storage Device 25 returns External Storage Identifying Data 35 to Media Player 16. Media Player 16 then encrypts said External Storage Identifying Data 35 by passing it through a software program referred to as Encryption Engine 36 resulting in Encrypted External Storage Identifying Data 32. Media Player 16 will then pass Encrypted Digital Content File 31 and Encrypted External Storage Identifying Data 32 through a software program referred to as Digital File Merging Process 33, resulting in Encrypted External Storage Identifying Data Merged With Encrypted Digital Content File 34.

Customer may use or play purchased Encrypted External Storage Identifying Data Merged With Encrypted Digital Content File 34 residing on Local Storage Device 25. Media Player 16 first scans the selected file to verify that the file is encrypted and that the file contains Encrypted External Storage Identifying Data 32. If Encrypted External Storage Identifying Data 32 is found, Media Player 16 decrypts the Encrypted External Storage Identifying Data 32, resulting in a first instance of External Storage Identifying Data 32. Media Player 16 then sends an inquiry command to the Local Storage Device 25. External Storage Device 25 returns a second instance of External Storage Identifying Data 35 to Media Player 16. Media Player 16 then compares the first and second instances of External Storage Identifying Data 35.

If the two data do not match, Media Player 16 will not play the selected file. Hence, this aspect verifies that a digital content file that was purchased cannot be copied from one local storage device to another local storage device and played. The customer is free to move Local Storage Device 25 from one media player to another and play the digital content files.

In another embodiment, Media Player 16 may be contained within Customer's Television 15 with the appropriate connector allowing Local Storage Device 25 to be connected to the television.

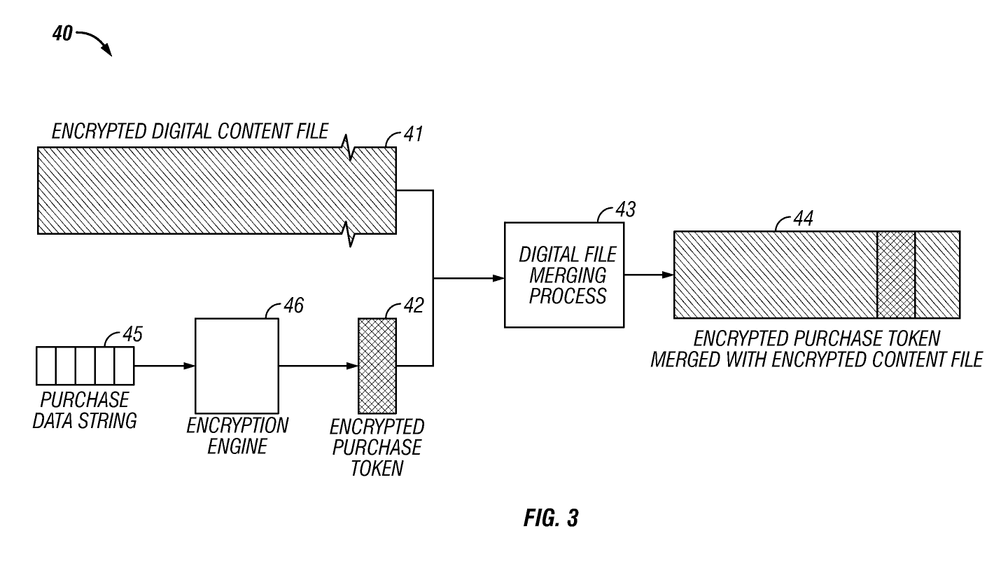

FIG. 3 is a diagram depicting how digital files residing on Rewritable Media 17 and purchased by the customer are marked as having been purchased such that Digital Content Rental System 12 can identify that the file has been purchased once Rewritable Media 17 has been returned to the system for processing. In this depiction 40, Encrypted Digital Content File 41 resides on Rewritable Media 17. If customer indicates a desire to purchase the Encrypted Digital Content File 41, Media Player 16 encrypts a Purchase Data String 45 by passing it through a software program referred to as Encryption Engine 46 resulting in Encrypted Purchase Token 42. Media Player 16 then passes Encrypted Digital Content File 41 and Encrypted Purchase Token 42 through a software program referred to as a Digital File Merging Process 43, resulting in Encrypted Purchase Token Merged With Encrypted Digital Content File 44. Customer then sends Rewritable Media 17 back to Digital Content Rental System 12. Once Rewritable Media 17 is received by Digital Content Rental System 12, the Rewritable Media 17 is inserted into Rewritable Media Device 23.

Rental Computer System 20 reads the contents of Rewritable Media 17. Each encrypted file residing on Rewritable Media 17 is examined to determine if Encrypted Purchase Token 42 is present in any of the files on Rewritable Media 17. If the Encrypted Purchase Token 42 is found, Rental Computer 20 debits customer's account for the purchases.

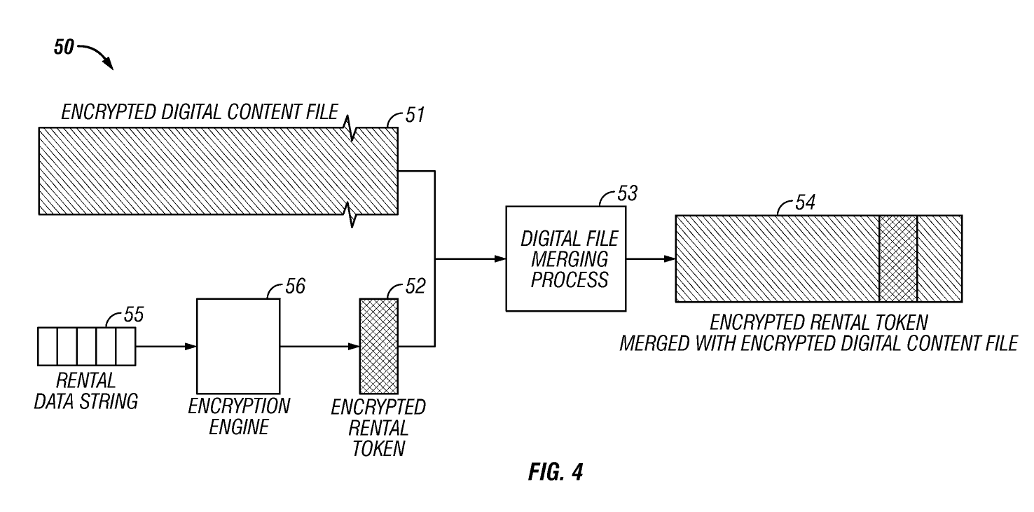

FIG. 4 is a diagram depicting how digital files not originally selected by the customer and residing on the rewritable media and played or used by the customer are marked as having been rented such that the system can identify that the file has been rented once the rewritable media has been returned to the system for processing. In this depiction 50, Encrypted Digital Content File 51 resides on Rewritable Media 17. If customer indicates a desire to rent said Encrypted Digital Content File 51, Media Player 16 encrypts a Rental Data String 55 by passing it through a software program referred to as Encryption Engine 56 resulting in Encrypted Rental Token 52. Media Player 16 then passes Encrypted Digital Content File 41 and Encrypted Rental Token 52 through a software program referred to as Digital File Merging Process 53, resulting in Encrypted Rental Token Merged With Encrypted Digital Content File 54. Customer then sends Rewritable Media 17 back to Digital Content Rental System 12. Once Rewritable Media 17 is received by Digital Content Rental System 12, said Rewritable Media 17 will be inserted into Rewritable Media Device 23. Rental Computer System 20 reads the contents of Rewritable Media 17. Each encrypted file residing on Rewritable Media 17 is examined to determine if Encrypted Rental Token 52 is present in any of the files on Rewritable Media 17. If said Encrypted Rental Token 52 is found, Rental Computer 20 will debit customer's account for the purchases.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of encryption and other kinds of media, as well as all kinds of players, are contemplated.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computer described herein may include any kind of computer, either general purpose, or some specific purpose computer such as a workstation. The computer may be an Intel (e.g., Pentium or Core 2 duo) or AMD based computer, running Windows XP or Linux, or may be a Macintosh computer.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A computer-implemented method for purchasing digital content comprising:
storing a database of customer information including digital content billing information on a first computer and also storing a database of digital content that can be rented and/or purchased;
responsive to receiving a request for a specific item of digital content from said database, transferring data files indicative of said specific item of digital content data files onto a rewriteable media;
physically delivering said rewritable media to a customer's address as indicated by said database;
physically receiving said rewritable media after access by said customer;
detecting a token that has been written on said rewritable media by said customer; and
billing said billing information stored in said database of information responsive to said detecting a token having been written.

2. A method as in claim 1, wherein said rewritable media is a flash drive device.

3. A method as in claim 1, wherein said token is an encrypted file that is written on the rewritable media.

4. A method comprising:
entering billing information into a database;
at a customer location, selecting one or more digital files to be rented; referenced in said database, for rent;
receiving rewritable media with said selected digital files physically at a customer location;
playing said digital files at said customer location;
receiving an option of purchasing said digital file just accessed by said customer; and
allowing purchase of said digital file without accessing the internet.

5. A media player comprising:
a computer module executing a software program contained on memory inside said media player;
a first connector contained in or on said media player capable of receiving rewritable media that is inserted into said media player;
said software program controlling said media player such that digital files can be read from said rewritable media connected to said media player through said connector;
a playing layer, within said software program, allowing said digital files to be played; and
a purchase option part, displaying a purchase message to a user, and allowing purchase of said digital files.

6. A player as in claim 5, further comprising a second connector associated with said media player capable of connecting an external storage device to said media player;
said software program controlling said media player such that digital files can be read from said rewritable media connected to first said connector and written to said external storage device through said second connector.

7. A player as in claim 5, wherein said purchase option part comprises an LED contained on said media player and controlled by said software program intended to communicate information to the customer.

8. A player as in claim 5, wherein said purchase option part comprises a textual display contained on said media player and controlled by said software program intended to communicate information to customer

9. The method of claim 1 where said first computer system also transfers digital files not selected by said customer to said rewritable media.

10. The method of claim 7 wherein:
a. Said software controlling said media player flashes said LED to indicate to customer that customer has the option of purchasing the digital file just played by said media player;
b. Said customer presses a button on said media player indicating a desire to purchase said digital file;
c. Said software program controlling said media player then reads said digital file from said rewritable media and writes said digital file to said external storage device.

11. The method of claim 1 wherein:
a. Said software program controlling said media player encrypts a series of characters thereby creating an encrypted file as said token;
b. Said software program then merges said token into the digital file residing on said rewritable media after said digital file has been transferred to said external storage device.
